(19) United States
(12) Patent Application Publication
(10) Pub. No.: US 2014/0358671 A1
(43) Pub. Date: Dec. 4, 2014

(54) SYSTEM AND METHOD FOR DETECTING FRAUDULENT ADVERTISEMENT ACTIVITY

(71) Applicant: Linkedln Corporation, Mountain View, CA (US)

(72) Inventor: Yawen Wei, San Francisco, CA (US)

(73) Assignee: Linkedln Corporation, Mountain View, CA (US)

(21) Appl. No.: 13/904,977

(22) Filed: May 29, 2013

(51) Int. Cl. G06Q 30/02

(52) U.S. Cl. CPC G06Q 30/0248
USPC 705/14.45

(57) ABSTRACT

A system and methods are provided for detecting fraudulent activity associated with advertisements, such as impression fraud (e.g., instigating excessive numbers of ad impressions), click fraud (e.g., clicking on or simulating clicking on excessive numbers of ad impressions), CTR fraud (e.g., higher than normal CTR and number of clicks) and conversion fraud (e.g., converting or simulating the conversions of excessive numbers of ad impressions). Converting an ad may entail completing a form, initiating a file download or taking other action after clicking on the ad. User activity that involves serving an ad or user interaction with an ad is monitored, and the rates of such activity are measured—such as rates at which ad requests are made, rates at which impressions are clicked on, and rates at which ads are converted. When a pattern of activity is deemed fraudulent, a fraud detection signal is issued.

### FIELD

This invention relates to computer systems and data processing. In particular, a system and methods are provided for detecting fraud in online activity relating to the serving of advertisements and interaction with served advertisements.

### BACKGROUND

Advertising is a staple of many online sites. A web site may serve advertisements to earn income, to advertise what is offered at the site, to provide public information and/or for other reasons. In cases in which a site serves advertisements of third parties, those third-party advertisers usually pay the site to publish the advertisements because the third parties hope to entice viewers into purchasing what they offer (e.g., with advertisements for goods and/or services), taking some action (e.g., with advertisements seeking volunteers, with advertisements regarding job openings), absorbing information (e.g., with advertisements regarding political candidates or consumer notifications), etc.

Because money is paid in exchange for the serving of ads and/or for action taken by viewers of served ads, dishonest people will naturally try to abuse the process for self gain. For example, an unscrupulous operator of a web site may contrive to generate activity that leads to additional payments from advertisers by operating an automated or manual system to initiate or simulate electronic visits to the site. Such visits will cause advertisements to be served, but they will be viewed by no one, or at least by no one who will ever purchase an advertised good or service. The dishonest operator may also, or instead, generate or simulate clicks on served ads to generate other revenue, but again without any possibility of generating a sale or other benefit for the advertiser.

### BRIEF DESCRIPTION OF THE DRAWINGS

FIG. 1 is a block diagram depicting a system for detecting fraudulent advertisement activity, in accordance with some embodiments of the invention.

FIGS. 2A-B are a flow chart illustrating a method of detecting fraudulent advertisement activity, in accordance with some embodiments of the invention.

FIG. 3 is a block diagram of an apparatus for detecting fraudulent advertisement activity, in accordance with some embodiments of the invention.

### DETAILED DESCRIPTION OF ILLUSTRATIVE EMBODIMENTS

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In embodiments of the invention, a system and method are provided for detecting fraudulent activity involving the serving of online advertisements and/or activity associated with such advertisements—such as clicks on the advertisements after they are served and/or action performed after clicking on an advertisement. In these embodiments, data reflecting user activity is collected and analyzed to identify patterns that may indicate some sort of fraud is being conducted. Among the types of frauds that may be detected are impression fraud, click fraud and conversion fraud.

In embodiments of the invention described herein, “impression fraud” is defined as causing excessive numbers of advertisements, impressions or creatives (collectively termed “advertisements” or “ads” herein) to be served. Each time a user navigates to or refreshes a page that contains an ad, another advertisement impression is requested and served from the advertisement-serving system.

Someone committing impression fraud may do so in order to generate greater income for the associated publisher (e.g., the operator of the site where the ads are served), if that publisher is paid on a CPM (cost per one thousand impressions) basis for example. Someone committing impression fraud has no interest in purchasing anything the advertisers are selling, and so the advertisers get no benefit from these ad impressions. A typical authentic user not committing fraud will not generate excessive quantities of ad requests.

“Click fraud” is defined as excessive action (e.g., clicking) on served advertisements. Whereas an authentic user may occasionally click on different ads, someone committing click fraud may repeatedly or frequently click on a single ad in order to exhaust a (daily) advertising budget for the corresponding advertiser, or may click on many different ads in order to generate greater income for the associated publisher, if that publisher is paid on a CPC (cost per click) basis for example.

“Click-through-rate” fraud (or CTR fraud) is defined as action (e.g., clicking) on a high percentage of served advertisements. A dishonest user may not engage in a level of activity that triggers detection of impression fraud or click fraud, but may nonetheless exhibit malicious intent. For example, whereas a normal user may click on ads only once in a while, such as 1 click among 1,000 impressions (yielding a CTR of 0.1%), a fraudulent actor may assemble a significantly higher CTR. In some embodiments of the invention, fraud will be suspected or assumed when a user's activity within a predetermined period of time (e.g., one hour, one day) matches or exceeds paired thresholds of CTR and either clicks or impressions.

“Conversion fraud” is defined as fraudulent activity regarding a served advertisement, other than clicking on it. For example, some ads, when clicked on, navigate the user to a form (e.g., a survey, a questionnaire), a subscription sign-up, a file download, a page view or some other follow-on action or request for information. A “conversion” occurs when the user performs such post-click activity.

A publisher may receive revenue when a visitor to the publisher's site converts an ad (e.g., if the publisher is paid on a CPA or cost-per-action basis), and a person committing conversion fraud thus increases a publisher's income and/or depletes an advertiser's ad budget, without having any real interest in the advertiser, a product or service of the advertiser or any other thing associated with the advertiser.

Embodiments of the invention may be implemented as part of virtually any online system or service that serves advertisements (or other content for which similar activity generates income), whether it is a social network service, a web server, an application server, a portal site, a search engine, etc. Some embodiments, for example, are implemented as part of a professional social networking site that promotes discovery of professional connections (e.g., work-related associations), creation of new connections, sharing of information, etc. The system may maintain large amounts of information regarding users' personal and professional attributes (e.g., gender, location, employer, job title, skills, education, experience), which may be used to select advertisements to serve alone or with content requested by a user or member.

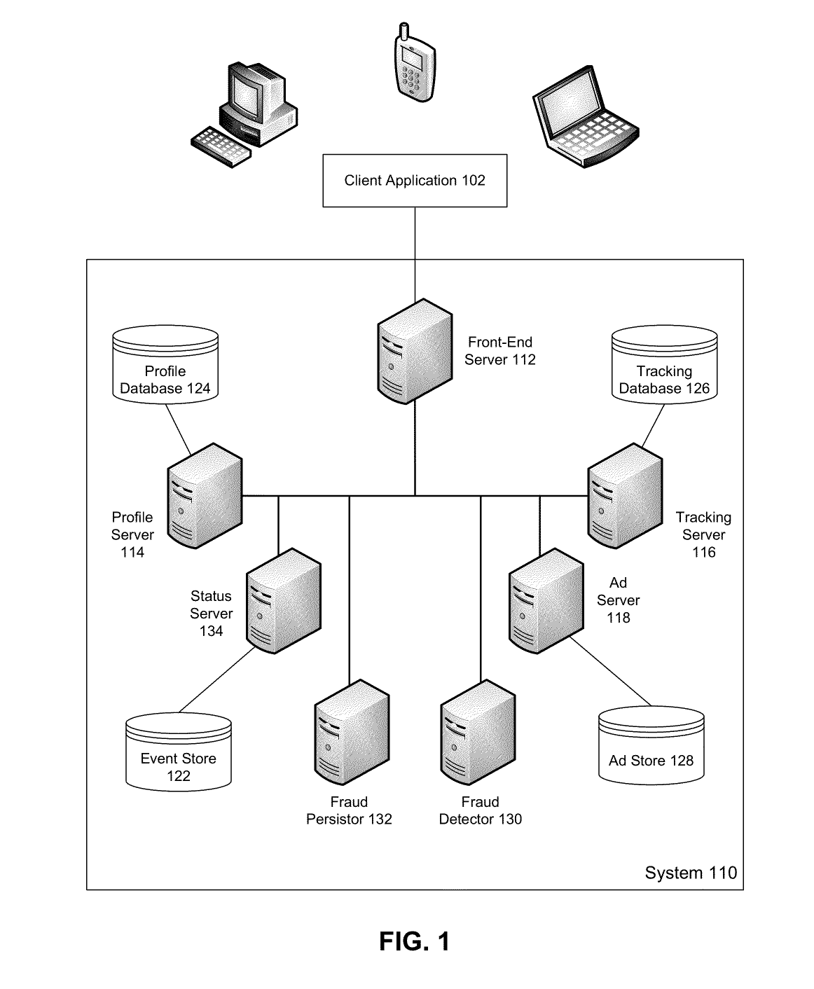

FIG. 1 is a block diagram of a system for serving advertisements and/or other content, according to some embodiments of the invention. In these embodiments, requests are received at front-end server 112, which may comprise a web server, application server, data server and possibly other software and/or hardware modules for serving content in response to requests. System 110 also includes profile server 114, tracking server 116, ad server 118, fraud detector 130, fraud persistor 132, profile database 124, tracking database(s) 126 and advertisement store 128.

System 110 may host a social networking service, a portal site, a search engine or some other service, which a user accesses via client software application 102. As part of the service, the system serves content for presentation to users via the client application. Client application 102 may be or may comprise a web browser or other application program capable of presenting content to a user, and may execute on a portable or stationary computing or communication device operated by a user.

Profile server 114 maintains profiles, in profile database 124, of users or members of a service hosted by system 110. A user's profile may reflect any number of attributes or characteristics of the user, including personal (e.g., gender, age range), professional (e.g., job title, employer, industry, experience, skills, professional endorsements), social (e.g., organizations of which the user is a member, geographic area of residence), educational (e.g., degree, university attended), etc. Users or members of a service offered by system 110 may be identified with user (or member) IDs or may be differentiated on the basis of some unique information, such as their network (e.g., IP) addresses, a hash of their browser identifiers, etc.

When an advertisement request or other content request is received at front-end server 112 from or on behalf of a user, the system may retrieve some or all data constituting the user's profile from the profile server. The profile data may be shared throughout system 110 to accompany and/or facilitate various actions or communications, such as when an advertisement is requested from ad server 118, when a record of activity is stored at tracking server 116, when analyzing a user's activity for indications of fraud at fraud detector 130, and so on.

Tracking server 116 monitors and records activity of system 110 (e.g., in tracking database(s) 126) and system users. For example, whenever content is served from front-end server 112 (e.g., to a client), the tracking server records what is served, to whom (e.g., which user), and when. Similarly, the tracking server also records user actions regarding content items presented to the users (e.g., clicks, conversions), to include identities of the user and the content item acted on, what action was taken, etc.

Ad server 118 maintains one or more repositories of advertisements for serving to users (e.g., ad store 128), and responds to ad requests passed to it from front-end server 112. When advertisements are stored at content server 118, they may be stored with attributes, indications, characteristics and/or other information describing one or more target audiences. For example, a provider of an advertisement may identify specific professional attributes of target users (and desired values for those attributes), a provider of a job listing may identify characteristics of users that should be informed of the opening, and so on. When selecting an ad to serve in response to a request, ad server 118 may match attributes of the user associated with the request with one or more advertisements targeting a subset of the user's attributes.

Fraud detector 130 monitors user activity for patterns of fraud that may be observed in advertisement requests initiated by the users and/or in the users' interactions with served ads (e.g., clicks, conversions). To facilitate this monitoring, every user activity—especially every ad request or response to an ad request, every user action or interaction with an ad, and every conversion of an ad—is reported to the fraud detector. This reporting may identify the user, the advertisement involved, the activity or action that occurred, the time, etc.

In some embodiments of the invention, fraud detector 130 looks for repeated activity of types indicative of fraud, within multiple discrete time periods that may run concurrently, to determine if the amount of activity that is observed in a time period likely corresponds to fraud. If a number of suspicious actions observed during one time period meets or exceeds a corresponding threshold, the fraud detector transmits a “fraud detection” signal to the ad server and/or other system components (e.g., fraud persistor 132).

A fraud detection signal may identify the user or member who committed the fraudulent activity, the type of fraud detected (e.g., impression fraud, click fraud, conversion fraud), how many actions were observed of the type corresponding to the fraud, and/or other information.

In an illustrative implementation of an embodiment of the invention, the fraud detector accumulates statistics for three time periods, which may be designated short, medium and long in duration. Illustratively, the short period may cover approximately 5-10 minutes, the medium period may cover approximately 1-2 hours and the long period may be approximately 1 day. The time periods monitored by fraud detector 130 may vary to a small or large degree. For example, in one alternative implementation, short, medium and long time periods are 1 hour, 1 day and 3 months, respectively. Another alternative implementation may employ just two periods, such as a “normal” period of 30 minutes and an “extended” period of 4 hours. Yet other alternative implementations use just one time period.

For each time period, fraud detector 130 counts the number of activities by one user, of one type, that may be fraudulent in nature. Counters for each period are incremented as the activities are identified, and if a threshold associated with any of the time periods and the different types of activities are reached, the fraud detector issues or emits the fraud detection signal. A mechanism other than separate counters may be employed in other embodiments of the invention. For example, timestamps of suspected activities may be recorded and the fraud detector may examine how many of a particular type have occurred during the different concurrent time periods.

At the end of each time period monitored by fraud detector 130, statistics collected for that time period (e.g., numbers of activities of each monitored type) are discarded and observation continues. Even if fraud by a given user was detected in each of multiple successive time periods, at the commencement of each new period fraud detector 130 acts as if the user has committed no fraud (e.g., the associated counters are reset). For example, in an implementation that uses counters, at the end of each short, medium and long period of time the counters of each type of suspicious activity are reset (i.e., cleared or set to zero) and collection of statistics begins anew for the new time period.

Although the fraud detector's fraud warnings are ephemeral, fraud persistor 132 records notifications of fraud so that they persist across multiple time periods. Depending on the user or member involved in the fraudulent activity, the type of fraud and/or other factors, fraud persistor 132 may store a persistent fraud notification for any period of time (e.g., days, weeks, months). For example, a persistent fraud record may last for 10 days if caused by impression fraud, and a record of click fraud or conversion fraud may be maintained for 30 days.

Each time a particular user is determined to have committed fraud, fraud persistor 132 may refresh a fraud setting for the identified user, which means a persistent fraud recordation may be renewed as often as every successive time period implemented by fraud detector 130. A fraud notation for a particular user may expire after a predetermined period of time if that user is not again observed to engage in fraudulent activity. A user's association with fraudulent activity may also be stored elsewhere, for any period of time, such as on profile server 114 and/or tracking server 116.

In some embodiments of the invention, the activities that are noted by fraud detector 130 and counted over one or more time periods include, but are not limited to, serving an advertisement to a user (or for presentation to a user), user interaction with a served advertisement (e.g., clicking on the ad) and conversion of an advertisement. As described above, conversion of an advertisement may entail clicking on it and taking follow-on action (e.g., completing a form, accepting a subscription, downloading a file).

Therefore, in these embodiments of the invention, for each concurrent or parallel period for which user activity is monitored (e.g., short, medium and long time periods), a separate set of counters is maintained for each active user (e.g., each user connected to the system). Within one set of counters for a user, separate counters are incremented every time that user is served an advertisement, clicks on an advertisement or converts an advertisement. Capturing this information allows the system (e.g., fraud detector 130) to detect impression fraud, click fraud and conversion fraud.

To detect impression-specific click fraud (or accidental multiple clicks) that occurs when a user clicks on a single ad more than once in a particular period of time (e.g., one day), the system (e.g., fraud detector 130, tracking server 116, ad server 118) stores identifiers of each advertisement served to each user during that period of time. Each time the system receives notification of a user interaction with an advertisement (e.g., a click), the system identifies the advertisement and determines whether the user previously interacted with that same ad within the period of time. If so, the second and subsequent actions on the ad are not charged to the advertiser.

For each type of ad-related user activity (e.g., serving an ad, interacting with an ad, converting an ad) and each time period (e.g., short, medium, long), a different threshold is set to identify levels of activity deemed fraudulent. In some embodiments of the invention, thresholds of activity that are deemed to be conclusive evidence of fraud are as follows. Other values may be enforced in other embodiments.

In these illustrative embodiments of the invention, impression fraud may be assumed when a user causes 100 advertisement impressions to be served in one 5-minute period, 1,000 impressions in one 1-hour period or 5,000 impressions in 1 day. Click fraud may be assumed when a user clicks on 10 ads in one 5-minute period, 20 ads in one 1-hour period or 100 ads in 1 day, or when the user clicks on the same ad more than once in one 24-hour period. CTR fraud may be assumed when a user exhibits a CTR greater than 0.7% and clicks on more than 5 ads within one hour, or a CTR greater than 0.4% and clicks on more than 15 ads within one day. Thus, CTR fraud may be found in activity that does not trigger a finding of click fraud or impression fraud. Conversion fraud may be assumed when a user converts more than 1 ad in one 5-minute period, more than 5 ads in one 1-hour period or more than 10 ads in 1 day. Depending on the number of time periods that are monitored and the duration of the time periods, these values may vary to a large or small degree in other embodiments of the invention.

Although the statistics (e.g., counter values) collected during one time period monitored by fraud detector 130 are cleared or reset at the end of the period in some embodiments of the invention, in other embodiments the time periods roll, meaning that each time period moves with the passage of time. For example, with 5-minute, 1-hour and 1-day periods, each period's collected data will reflect all activity within the most recent 5 minutes, the most recent hour and the most recent day, respectively. As time passes, the activity counters or other mechanism(s) will decrement or otherwise change as individual actions or activities become too old to be included in the current time period(s) (assuming no new activities are received that will cause the counters to increment).

In some embodiments of the invention, data collected by system 110 are analyzed to determine better or more appropriate thresholds at which to declare a pattern of activity or number of actions fraudulent. Data used to fashion these thresholds may include, but is not limited to: time span between serving an ad impression and a click on that impression, distribution of clicks by one user, distribution of clicks received from one network (e.g., IP) address, distribution of ad impressions for users and/or network addresses, and variations of click-through rates by users.

Until a user's activity meets or exceeds a corresponding threshold, the system may continue to respond to ad requests and user interactions in a normal fashion, charge (or bill or debit, etc.) an advertiser based on their bid for the activity, and so on. However, once a user's activity of a particular type is deemed fraudulent, further activity by that user, of the same and/or other types, will not be charged to advertisers. In different implementations, the system will refrain from charging advertisers for that user's activity (or will refund payments as necessary) for different lengths of time (e.g., one day, one week, one month), but this time may be extended if the user is again found to commit fraud during the initial length of time.

In some embodiments of the invention, a reconciliation process is executed once per day or with some other regularity. During reconciliation, the system determines whether, and to what extent, it charged advertisers and/or other parties for activity that it subsequently deemed was fraudulent. For example, until a user exceeds one of the thresholds described above, the system may charge or debit an advertiser for serving an ad and/or obtaining user interaction with an advertisement. During reconciliation the system determines how much it overcharged an advertiser and either refunds that amount, applies it as a credit toward future activity or otherwise makes the advertiser whole.

In some embodiments of the invention, as each activity or event is reported to fraud detector 130, it responds with a status. That status may be the fraud detection signal (if fraud is detected), may be a “normal” or “okay” status to indicate that the event does not complete a predetermined pattern of fraud (e.g., does not trigger a fraud threshold), or may be some other status.

In some embodiments of the invention, a “warning” status may be signaled when a user's level of activity approaches a threshold interpreted as fraud, but does not yet cross that threshold. For example, the “warning” status may be signaled when a user's number of clicks within a five-minute window reaches 5, if the number needed to announce fraud is 10.

In different implementations, a warning status may trigger different action. For example, it may cause the system to begin flagging activity (e.g., ad-servings) to this user. This may help the system identify fraudulent events more easily if and when the user's activity does rise to the level of fraud (e.g., by reaching 10 clicks in the five-minute period). Illustratively, after the fraud declaration, the system may simply review events for which “warning” or “fraud” was signaled, instead of having to review more activity.

In another implementation, the system may consider the “warning” status when choosing which ad to serve to the user (until his/her status returns to normal). For example, the system may reduce the likelihood of serving higher-value ads (because if fraud is found the system may have to refund the corresponding advertiser), may increase the likelihood of serving lower-value ads or even ads that have already expended their daily budget, etc.

In some embodiments, system 110 includes a component for storing statuses of all user events or actions during one day (or other duration of time). This component may be fraud persistor 132, tracking server 116, status server 134, some other component depicted in FIG. 1, or a component not depicted. In these embodiments, status server 134 is involved in the reconciliation process described above, to identify which events were fraudulent (for which advertisers should not be charged) and which were not (for which advertisers should be charged).

In some embodiments of the invention, functionality of the system components illustrated in FIG. 1 and/or functions described above may be distributed differently, among the same components, a subset of the illustrated components, or a superset of the illustrated components. For example, functions ascribed to one component may be performed by a different component, a single component's role(s) may be divided among two or more other components, multiple components may be merged, etc.

While depicted as separate hardware components (e.g., computer servers) in FIG. 1, components such as front-end server 112, profile server 114, tracking server 116, content server 118, fraud detector 130 and fraud persistor 132 may alternatively be implemented as separate software modules executing on one or more computer servers. Thus, some or all of the components of system 110 may be virtual computers hosted by a single computer server or set of cooperative computer servers, while remaining components may comprise discrete computer servers. Each computer server of system 110 may include a set of one or more processors, memory, storage and other components, as would be understood by one of ordinary skill in the art.

In some embodiments of the invention, system 110 not only serves advertisements to visitors to a web site or service hosted by the system, but may also bid to serve advertisements for presentation on or via other sites (e.g., as part of an advertising network).

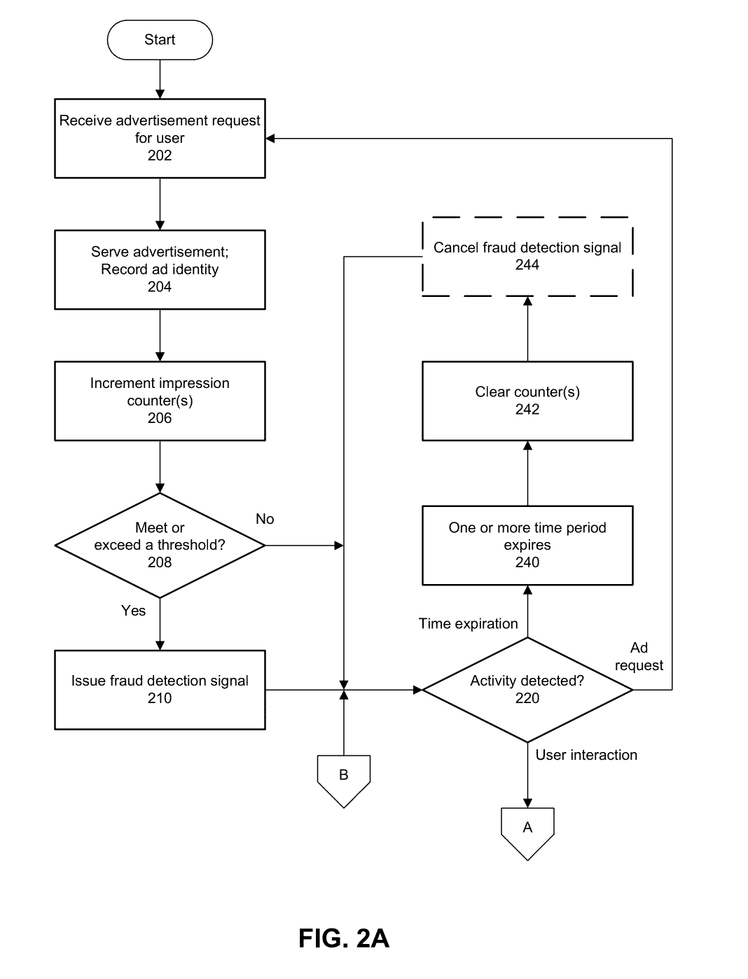

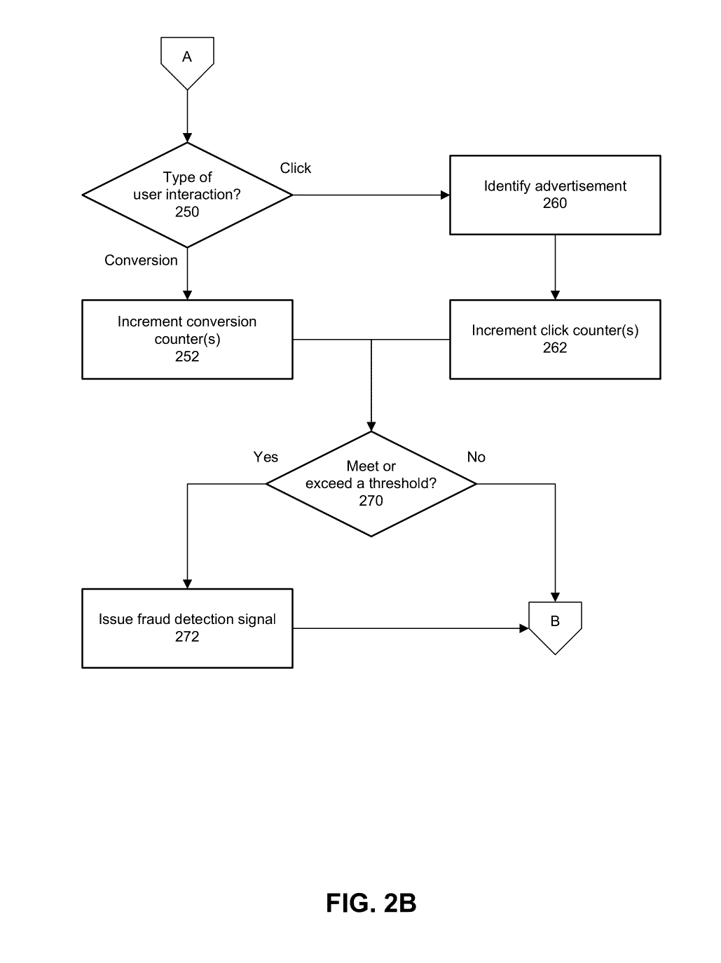

FIG. 2 is a flow chart illustrating a method of detecting fraudulent advertisement activity, according to some embodiments of the invention. In these embodiments, a system for serving advertisements, or a system that serves ads and other content, monitors user activity for indications of fraud.

In operation 202, the system receives a request to serve an advertisement for presentation to a user. Illustratively, the ad request may be received from a browser or other application operated by a client computing device of the user, or may be received from a third party site or system in order to receive an advertisement to be served to a user at that site or system.

In some embodiments of the invention, an identifier of the user is received with the request, or is retrievable based on metadata, tags or other information that accompanies the request. In other embodiments, different users may be differentiated by IP (Internet Protocol) address, browser identifier or some other unique information. Based on information received with the request, the system may be able to identify one or more attributes of the user to whom the requested ad will be presented—such as location, gender, job title, skills, industry in which he or she is employed, etc.

In operation 204, the system selects and serves an advertisement in response to the request. Illustratively, information about the user received with the request, or retrieved using information included with the request, allows the system to match the user with an advertisement that has a target audience that includes the user (e.g., as defined by one or more attributes or characteristics specified by the corresponding advertiser).

Also in operation 204, the system records which advertisement (e.g., which specific creative) was served for the user, a timestamp identifying when it was served and/or other information (e.g., the format with which it was served, a destination address to which it was sent). This information may be recorded by a system component that monitors user activity for fraud (e.g., fraud detector 130 of FIG. 1) and/or by other components (e.g., a component that is designed specifically to track the serving of advertisements, such as tracking server 116 of FIG. 1).

In operation 206, one or more impression counters associated with the user are incremented. Separate counters may be implemented for one or more concurrent time durations, in order to monitor the rate at which advertisement impressions are served to the user. If this is the first ad served to the user during his or her current session, operation 206 may also involve creation or initialization of the counters. In some embodiments of the invention, and as described previously, multiple concurrent time periods are monitored so that a person committing fraud will be caught if he or she performs a significant amount of activity within any period of time.

In operation 208, the system determines whether this activity—the serving of an ad, when aggregated with previous activity of the user (e.g., other ad requests)—appears to indicate that the user is engaged in fraud. In particular, the system (e.g., fraud detector 130 of FIG. 1) may compare the counters updated in operation 206 to predetermined thresholds. The thresholds may be updated regularly or from time to time, based on individual users, their locations, their addresses, how long they have been users or members and/or other factors. To allow the system to monitor each user action, each such action may be reported to a fraud detector or other system component specifically designed to monitor user activity for fraud.

If fraud is identified or suspected (e.g., because a counter has reached or exceeded a corresponding threshold), the illustrated method advances to operation 220; otherwise, the method continues at operation 210.

In operation 210, the fraud detector or other system component that is monitoring user activity issues a fraud detection signal to announce the detection. As part of operation 210, or following operation 210, a persistent record of the fraud detection for this user is made (e.g., on fraud persistor 132 of FIG. 1). The fraud detector that discovered the fraud may reset or cancel the fraud status at the end of the time period corresponding to the counter that triggered the alert. A fraud persistor or other system component therefore records the fraud alert to ensure it is remembered for some period of time (e.g., 10 days, 20 days, 1 month). After operation 210, the method continues to operation 220 to monitor the user's next action (e.g., until the user disconnects or his/her session ends).

In operation 220, the method awaits and acts on further activity related to this user. If another ad request for the user is received, the method returns to operation 202. If a time period corresponding to an active counter (e.g., an impression counter, a click counter, a conversion counter) expires, the method continues to operation 240. If user interaction with an ad is detected, the method advances to operation 250.

In operation 240, one or more time periods corresponding to a counter that is tracking the user's activity expire.

In operation 242, the expired timer(s) is or are cleared or reset.

In optional operation 244, if a fraud detection signal associated with a counter corresponding to one of the expired time periods was active or asserted, it may now be cancelled or de-asserted. Illustratively, as each user action is delivered or reported to the fraud detector or other system component that is monitoring the action for fraud, the detector may return a signal or status to indicate whether the action is part of a pattern of fraud. Alternatively, actions or events may be received without exclamation, as long as they do not complete a recognized pattern (or level) of fraud. Once a pattern of fraud is detected, however, the detector may respond to additional actions of the same type as being fraudulent, until the corresponding counter is reset when the associated time period expires.

In some embodiments of the invention, therefore, the persistent record of user fraud created during or after operation 210 will help the system determine whether and/or how much user activity should not be charged to advertisers, even though the fraud detector will stop signaling fraud after the expiration of a time period in which it first occurred. Of course, if the user's activity in a subsequent time period again causes the corresponding counter to meet or exceed its threshold, the detector will again issue the fraud detection signal. After optional operation 244, the method returns to operation 220 to act on the user's next activity (e.g., until the user disconnects or his/her session ends).

In operation 250, the user has engaged in some type of interaction with an advertisement. If the interaction involves clicking on or otherwise selecting the ad, the method advances to operation 260; if the interaction involves a conversion of the ad, the method continues at operation 252.

In operation 252, one or more conversion counters are incremented. If this is the first ad served to the user during his or her current session, operation 252 may also involve creation or initialization of the conversion counter(s).

Illustratively, multiple conversion counters may be implemented for each of multiple concurrent time periods (e.g., as with the impression counters). In some embodiments of the invention, the system does not differentiate between conversions committed by the user—they are all aggregated. In other embodiments, however, the system may differentiate based on the advertisement converted, the campaign (i.e., the advertising campaign to which the impression that was converted belongs), the advertiser, the type of conversion (e.g., completion of a survey, accepting a subscription), and/or other factors. In these embodiments, each basis for differentiation may have its own set of conversion counters. After operation 252, the illustrated method continues at operation 270.

In operation 260, the system identifies the advertisement that was selected or clicked on. An identity of the advertisement may be received with notification of the action from the user's browser, for example.

In operation 262, one or more click counters are incremented. If this is the first ad served to the user during his or her current session, operation 262 may also involve creation or initialization of the click counter(s).

Illustratively, multiple click counters may be implemented for each of multiple concurrent time periods (e.g., as with the impression counters). In some embodiments, separate counters may also be maintained for individual creatives or impressions, campaigns, advertisers and/or other aggregations of advertisements. Alternatively, identities of each ad impression or creative the user clicks on may be stored for some period of time after each click (e.g., 1 hour, 1 day, 1 week); this information may be used as described below to catch duplicate user action. After operation 262, the method continues at operation 270.

In operation 270, the system determines whether any counter just updated (e.g., in operation 252 or operation 262) has reached or exceeded a corresponding threshold that indicates fraud. As with the impression counters, each conversion counter and click counter may have a different threshold, and any or all of those thresholds may be updated from time to time or on a regular basis. If any counter met or passed the applicable threshold, the illustrated method continues at operation 272; otherwise, the method returns to operation 220 to deal with the next user activity (e.g., until the user disconnects or his/her session ends).

In operation 272, the fraud detector or other system component that monitors user activity issues a fraud detection signal to alert system components of the detection. As part of operation 272, or following operation 272, a persistent record of the fraud detection for this user is made (e.g., on fraud persistor 132 of FIG. 1). The fraud detector that discovered the fraud may reset or cancel the fraud status at the end of the time period corresponding to the counter that triggered the alert. A fraud persistor or other system component therefore records the fraud alert to ensure it is remembered for some period of time (e.g., 10 days, 20 days, 1 month). After operation 272, the method returns to operation 220 to detect and identify the user's next action (e.g., until the user disconnects or his/her session ends).

In some embodiments of the invention, in order to catch duplicate user action (e.g., clicking on a single ad), which may occur by accident or as a pattern of fraud, the system compares the identity of an ad that was clicked on (as determined in operation 260), with identities of ads previously stored (in operation 204) within the same period of time for which duplicate actions are monitored (e.g., 1 hour, 1 day, 1 week). If a match is found, a fraud detection signal may be raised or, alternatively, the duplicate action may be suppressed (e.g., not reported to a system component that would bill or charge the corresponding advertiser). If repeated action on the same ad is detected (e.g., with an ad-specific click counter), fraud is likely and the fraud detection signal may be raised.

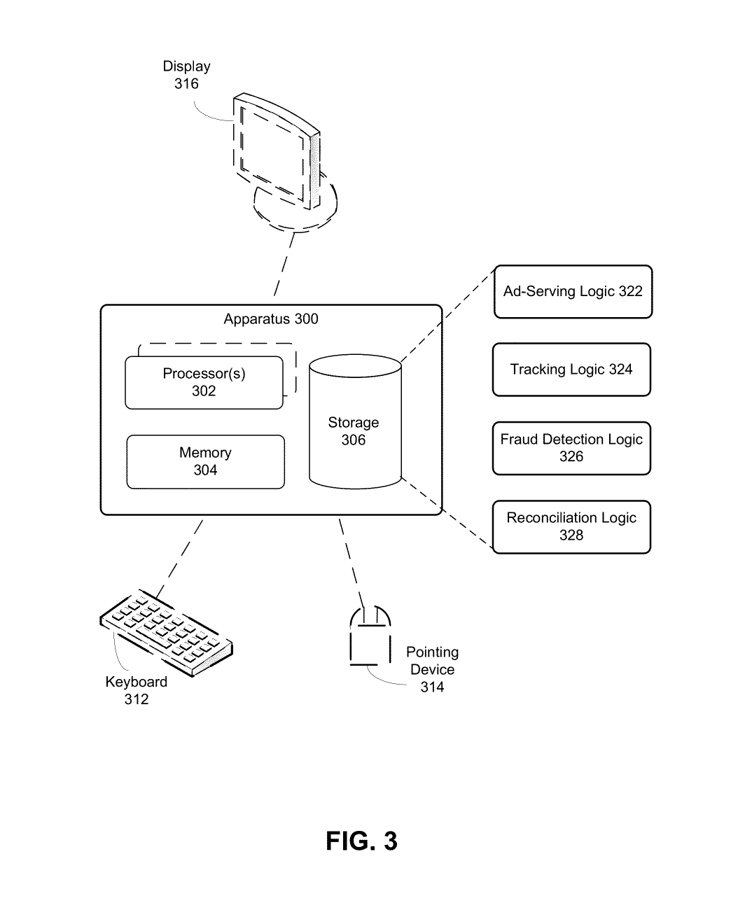

FIG. 3 is a block diagram of an apparatus for detecting fraudulent advertisement activity, according to some embodiments of the invention.

Apparatus 300 of FIG. 3 comprises one or more processors 302, memory 304 and storage 306, which may comprise one or more optical and/or magnetic storage components. In embodiments of the invention in which apparatus 300 comprises multiple processors, the processors may operate within one physical computing device or may operate in multiple different computing devices. In these embodiments, each device may also have separate memory and/or storage device elements. Apparatus 300 may be coupled (permanently or temporarily) to keyboard 312, pointing device 314 and display 316.

Memory 304 stores counters (e.g., impression counters, click counters, conversion counters), ad identifiers (e.g., identifiers of served impressions), statuses of user actions/events (e.g., valid, invalid or fraudulent), thresholds of one or more types of user activity that may be monitored, fraud notifications or alerts, other data, and/or logic manipulated during operation of apparatus 300.

Storage 306 of the apparatus may store content (e.g., advertisements) for serving to/for users, user data (e.g., profiles), tracking data, historical data and/or other information. Storage 306 also stores logic that may be loaded into memory 304 for execution by processor(s) 302. Such logic includes ad-serving logic 322, tracking logic 324, fraud detection logic 326 and reconciliation logic 328. In other embodiments of the invention, any or all of these logic modules or other content may be combined or divided to aggregate or separate their functionality as desired.

Ad-serving logic 322 comprises processor-executable instructions for receiving content (e.g., ad) requests, selecting content to serve, responding to the content requests and/or other action. Logic 322 may identify the user associated with a user action (e.g., based on an accompanying or retrievable user ID) or differentiate between different users (e.g., based on address, browser).

Tracking logic 324 comprises processor-executable instructions for recording what is served, to whom, when it was served, any follow-on user activity (e.g., click, conversion), etc. Tracking logic may also store fraud notifications or other information identifying a user who has been deemed to have engaged in fraudulent activity.

Fraud detection logic 326 comprises processor-executable instructions for monitoring user activity for fraud. Logic 326 may employ various counters and/or other mechanisms or schemes to determine how much of a particular type of activity occurs during one or more time periods, thresholds of such activity that indicate fraud, and/or other data. Fraud detection logic 326 is also configured to issue fraud alerts or signals when it detects a pattern of fraud. Such alerts may be stored transiently and/or persisted for longer periods of time.

Reconciliation logic 328 comprises processor-executable instructions for reconciling user activity during a discrete time period (e.g., one day). The reconciliation logic may be executed as a batch process (e.g., every day) and/or interactively as warranted. As part of the reconciliation process, logic 328 may ensure that advertisers are credited, refunded or otherwise not charged for user activity that would normally require payment to an operator of apparatus 300 from the advertisers, but that is nullified because the activity has been deemed fraudulent.

The environment in which some embodiments of the invention are executed may incorporate a general-purpose computer or a special-purpose device such as a hand-held computer or communication device. Details of such devices (e.g., processor, memory, data storage, display) may be omitted for the sake of clarity.

Data structures and code described in this detailed description are typically stored on a non-transitory computer-readable storage medium, which may be any device or medium that can store code and/or data for use by a computer system. Non-transitory computer-readable storage media includes, but is not limited to, volatile memory, non-volatile memory, magnetic and optical storage devices such as disk drives, magnetic tape, CDs (compact discs), DVDs (digital versatile discs or digital video discs), or other non-transitory computer-readable media now known or later developed.

The methods and processes described in the detailed description can be embodied as code and/or data, which can be stored in a non-transitory computer-readable storage medium as described above. When a processor or computer system reads and executes the code and/or data stored on the medium, the processor or computer system performs the methods and processes embodied as data structures and code and stored within the medium.

Furthermore, the methods and processes described below can be included in hardware modules. For example, the hardware modules may include, but are not limited to, application-specific integrated circuit (ASIC) chips, field-programmable gate arrays (FPGAs) and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

1. A computer-implemented method of detecting fraud related to online advertisements, the method comprising:
serving an advertisement for presentation to a user;
if the user interacts with the advertisement, receiving notification of the interaction;
operating one or more processors of the computer to:
increment a count of advertisements served to the user;
increment a count of user interactions only if the user interacts with the advertisement; and
determine whether the user previously interacted with the advertisement within a first time period; and
reconciling all servings of the advertisement during the first time period by:
identifying one or more fraudulent activities of the user involving at least one advertisement; and
crediting, to advertisers corresponding to the at least one advertisement, value normally paid by the advertisers in association with the fraudulent activities.

2. (canceled)

3. The method of claim 1, wherein incrementing the count of advertisements served to the user comprises:
incrementing a first count of advertisements served to the user during a short time period;
incrementing a second count of advertisements served to the user during a medium time period; and
incrementing a third count of advertisements served to the user during a long time period;
wherein the short time period, the medium time period, and the long time period are concurrent.

4. The method of claim 3, wherein:
the short time period is approximately five minutes;
the medium time period is approximately one hour; and
the long time period is approximately one day.

5. The method of claim 3, wherein the one or more processors are further operated to:
compare the first count to a first threshold;
compare the second count to a second threshold; and
compare the third count to a third threshold;
wherein the first threshold, second threshold and third threshold are different from each other.

6. The method of claim 5, wherein:
the first threshold is at least 100;
the second threshold is at least 1,000; and
the third threshold is at least 5,000.

7. The method of claim 1, wherein incrementing the count of user interactions comprises:
incrementing a first count of user interactions that occurred during a short time period;
incrementing a second count of user interactions that occurred during a medium time period; and
incrementing a third count of user interactions that occurred during a long time period.

8. The method of claim 7, wherein:
the short time period is approximately five minutes;
the medium time period is approximately one hour; and
the long time period is approximately one day.

9. The method of claim 7, wherein the one or more processors are further operated to:
compare the first count to a first threshold;
compare the second count to a second threshold; and
compare the third count to a third threshold;
wherein the first threshold, second threshold and third threshold are different from each other.

10. The method of claim 9, wherein:
the first threshold is approximately 10;
the second threshold is approximately 20; and
the third threshold is approximately 100.

11. The method of claim 1, wherein:
the count of advertisements and the count of user interactions are maintained in non-persistent storage;
if the count of advertisements exceeds an advertisement-count threshold, storing a first notification in persistent storage; and
if the count of user interactions exceeds a user-interaction-count threshold, storing a second notification in the persistent storage.

12. The method of claim 1, wherein determining whether the user previously interacted with the advertisement within a first time period comprises:
comparing an identifier of the advertisement with stored identifiers of other advertisements previously served for presentation to the user during the first time period.

13. A non-transitory computer-readable medium storing instructions that, when executed by a processor, cause the processor to perform a method of detecting fraud related to online advertisements, the method comprising:
serving an advertisement for presentation to a user;
if the user interacts with the advertisement, receiving notification of the interaction;
incrementing a count of advertisements served to the user;
incrementing a count of user interactions only if the user interacts with the advertisement;
determining whether the user previously interacted with the advertisement within a first time period; and
reconciling all servings of the advertisement during the first time period by:
identifying one or more fraudulent activities of the user involving at least one advertisement; and
crediting, to advertisers corresponding to the at least one advertisement, value normally paid by the advertisers in association with the fraudulent activities.

14. A system for detecting fraud related to online advertisements, the system comprising:
one or more processors;
ad-serving logic executable by the one or more processors to:
serve an advertisement for presentation to a user; and
if the user interacts with the advertisement, receive notification of the interaction;
tracking logic executable by the one or more processors to:
increment a count of advertisements served to the user;
increment a count of user interactions only if the user interacts with the advertisement; and
determine whether the user previously interacted with the advertisement within a first time period; and
reconciliation logic executable by the one or more processors to reconcile all servings of the advertisement during the first time period by:
identifying one or more fraudulent activities of the user involving at least one advertisement; and
crediting, to advertisers corresponding to the at least one advertisement, value normally paid by the advertisers in association with the fraudulent activities.

15. (canceled)

16. (canceled)

17. The system of claim 14, wherein incrementing the count of advertisements comprises:
incrementing a first count of advertisements served to the user during a short time period;
incrementing a second count of advertisements served to the user during a medium time period; and
incrementing a third count of advertisements served to the user during a long time period;
wherein the short time period, the medium time period, and the long time period are concurrent.

18. The method of claim 17, further comprising comparison logic executable by the one or more processors to:
compare the first count to a first threshold;
compare the second count to a second threshold; and
compare the third count to a third threshold;
wherein the first threshold, second threshold and third threshold are different from each other.

19. The method of claim 17, wherein incrementing the count of user interactions comprises:
incrementing a first count of user interactions that occurred during the short time period;
incrementing a second count of user interactions that occurred during the medium time period; and
incrementing a third count of user interactions that occurred during the long time period.

20. The system of claim 19, wherein:
the short time period is approximately five minutes;
the medium time period is approximately one hour; and
the long time period is approximately one day.
